(19) United States
(12) Patent Application Publication
(10) Pub. No.: US 2025/0390197 A1
(43) Pub. Date: Dec. 25, 2025

(54) ROTATABLE USER INTERFACE ELEMENTS

(71) Applicant: Very 360 VR LLC, Woodland Hills, CA (US)

(72) Inventors: Dmitriy Pinskiy, Woodland Hills, CA (US); Eric Michael Rubin, Nevada City, CA (US)

(21) Appl. No.: 19/221,137

(22) Filed: May 28, 2025

Related U.S. Application Data
(60) Provisional application No. 63/662,150, filed on Jun. 20, 2024.

(51) Int. Cl. G06F 3/04815; G06F 3/0486

(52) U.S. Cl. CPC G06F 3/04815; G06F 3/0486

(57) ABSTRACT

Systems and methods for rendering scenes on rotatable elements in a graphical user interface. Systems and methods include storing a concealed scene and an initial scene on file servers, retrieving scene data to render scenes on different sides of a rotatable element, with no limitation as to how many times such a rotatable element can rotate to reveal new scenes. User inputs such as clicks and drags are received to determined how to rotate a rotatable element to facilitate seamless transitions and enhanced interactivity within the interface.

This application claims priority to U.S. Provisional Patent Application No. 63/662,150, filed Jun. 20, 2024. All extrinsic materials identified in this application are incorporation by reference in their entirety.

### FIELD OF THE INVENTION

The field of the invention is rotatable user interface elements.

### BACKGROUND

The background description includes information that may be useful in understanding the present invention. It is not an admission that any of the information provided in this application is prior art or relevant to the presently claimed invention, or that any publication specifically or implicitly referenced is prior art.

The evolution of graphical user interfaces (GUIs) has significantly enhanced the way users interact with computing systems. Traditional user interfaces often rely on static elements, such as buttons, menus, and icons, to facilitate navigation and functionality. While these designs have served their purpose, they often lack dynamic interactivity and intuitive responsiveness, which are increasingly demanded in modern applications. Prior art has explored the inclusion of movable and interactive elements within GUIs, but they often suffer from limitations, such as insufficient rendering capabilities, restricted user inputs, and an inability to provide seamless transitions between different states or views of the elements.

Existing approaches to interactive GUI components, such as rotatable elements, have generally been constrained by technical inefficiencies. For example, many of these systems do not adequately address the challenges of accurately rendering multiple sides of an object in response to user input, such as mouse movements or touch gestures. Furthermore, these systems often fail to incorporate robust metadata frameworks that ensure proper adjacency and connectivity between scenes. As a result, user interfaces employing rotatable elements may exhibit delayed responses, poor visual fidelity, or restricted versatility, limiting their applicability in sophisticated computing environments.

Therefore, the state of the art could be improved by introducing advanced systems and methods for embedding rotatable elements within GUIs. By leveraging a resource manager, initial and concealed scene loaders, and a comprehensive metadata structure, user interfaces can seamlessly load and render both visible and hidden sides of a rotatable element in a manner that is computationally efficient and eliminates stuttering or other visual lag, improving the user experience through enhanced interactivity and visual coherence.

It has yet to be appreciated that rotatable elements can be implemented into user interfaces a way that is computationally efficient, reduces or eliminates visual stuttering, and improves user experience and content density within the user interface.

### SUMMARY OF THE INVENTION

The present invention provides apparatuses, systems, and methods are directed to implanting rotatable elements in graphical user interfaces. In one aspect of the inventive subject matter, a method of loading and displaying a rotatable element in a user interface comprises the steps of: running, on a computing device, a resource manager; spawning a concealed scene loader using the resource manager; spawning an initial scene loader using the resource manager; retrieving a concealed scene from concealed scene storage using the concealed scene loader; retrieving an initial scene from initial scene storage using the initial scene loader; retrieving rotatable element metadata using the resource manager; rendering the initial scene to form a first side of the rotatable element while the rotatable element is in an initial angular orientation; receiving, by the computing device, a user input comprising a mouse movement or a touch movement; determining a new angular orientation of the rotatable element according to the user input; comparing the new angular orientation to the initial angular orientation to determine whether to render the concealed scene; and rendering the concealed scene to form a second side of the rotatable element opposite the first side.

In some embodiments, the concealed scene storage comprises a file server, and the initial scene storage comprises a file server. The rotatable element metadata can include one or any combination of: scene adjacency information, information delineating connectivity between scenes, an identification of the initial scene, and at least one URL corresponding to an asset from the initial scene. In some embodiments, the user input comprises a click and drag originating on a graphical representation of the rotatable element.

In another aspect of the inventive subject matter, a method of loading and displaying a rotatable element in a user interface comprises the steps of: running, on a computing device, a resource manager; retrieving a first scene from initial scene storage using the resource manager; retrieving a second scene from concealed scene storage using the resource manager; retrieving rotatable element metadata using the resource manager; rendering the first scene to form a first side of the rotatable element; receiving, by the computing device, a user input comprising a mouse movement or a touch movement; determining a movement of the rotatable element according to the user input; comparing a new angular orientation to an initial angular orientation of the rotatable element to determine whether to render the second scene, wherein the new angular orientation is determined based on the movement, where the new angular orientation causes a second side of the rotatable element to be visible; and rendering the second scene to form a second side of the rotatable element.

In some embodiments, the concealed scene storage comprises a file server, and the initial scene storage can also comprises a file server. In some embodiments, the rotatable element metadata comprises at least one of: scene adjacency information; information delineating connectivity between scenes; an identification of the first scene; and at least one URL corresponding to an asset from the first scene. The user input can include a click and drag originating on a graphical representation of the rotatable element.

In another aspect of the inventive subject matter, a method of loading and displaying a rotatable element in a user interface comprises the steps of: running, on a computing device, a resource manager; spawning a scene loader using the resource manager; retrieving, using the scene loader, a concealed scene from scene storage; retrieving, using the scene loader, an initial scene from the scene storage; retrieving rotatable element metadata using the resource manager; rendering the initial scene to form a first side of the rotatable element while the rotatable element is in an initial angular orientation; receiving, by the computing device, a user input comprising a mouse movement or a touch movement; determining a new angular orientation of the rotatable element according to the user input; comparing the new angular orientation to the initial angular orientation to determine whether to render the concealed scene; and rendering the concealed scene to form a second side of the rotatable element opposite the first side.

In some embodiments, the scene storage comprises a file server. The rotatable element metadata can include one or any combination of scene adjacency information, information delineating connectivity between scenes, an identification of the initial scene, and at least one URL corresponding to an asset from the initial scene. In some embodiments, the user input can include a click and drag originating on a graphical representation of the rotatable element.

One should appreciate that the disclosed subject matter provides many advantageous technical effects including the ability to increase GUI information and content density via easy-to-use interactive elements. Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A shows a user interface having a rotatable element.

FIG. 1B shows the user interface with the rotatable element partially rotated.

FIG. 1C shows the user interface with the rotatable element rotated further.

FIG. 1D shows the user interface with the rotatable element fully rotated.

FIG. 2 shows a user interface with a rotatable element that reveals a three-dimensional object.

FIG. 3 shows a virtual camera in relation to a rotatable element.

FIG. 4 shows an example data structure for a rotatable element of the inventive subject matter.

FIG. 5 is a flowchart describing an embodiment of the inventive subject matter.

FIG. 6 shows a schematic of a resource manager of the inventive subject matter.

FIG. 7 shows a schematic of hardware components that can be used in embodiments of the inventive subject matter.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the language expressing numbers, number ranges, quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Systems and methods of the inventive subject matter are directed improving content density in a user interface by leveraging three-dimensional rotatable elements that, upon rotation, reveal additional content. Embodiments can be incorporated into any digital user interface, including web pages and application user interfaces. By incorporating rotatable elements into a user interface, the amount of content that can be accessed from a given user interface can be increased.

Rotatable elements of the inventive subject matter are elements of a user interface or webpage that are rotated in three-dimensional space. For example, if a user is scrolling down a webpage, they may come across a rotatable element that appears in-line with the rest of the webpage. Rotatable elements comprise scenes, where scenes are shown on surfaces of rotatable elements. Throughout this application, a scene may be described as being “on” a side of a rotatable element, when in actuality it may be the case that a scene forms the side of the rotatable element such that rotatable elements are emergent structures that exist because scenes are rendered back-to-back, so to speak. Whether a scene is described as being “on” a side or “as” a side of a rotatable element does not change the nature of the rotatable element. By rotating a rotatable element, a scene that is hidden behind that rotatable element's initially visible scene is revealed. In some embodiments, a rotatable element can be rotated multiple times in a single direction, thus allowing a rotatable element to reveal more scenes than a real-world two-sided rotating sign could reveal.

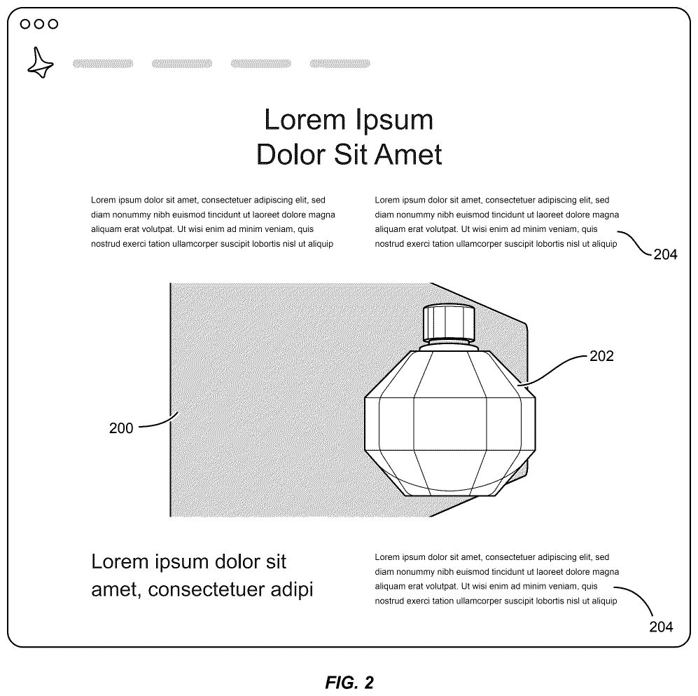

Content that can be displayed according to an orientation a rotatable element can thus be referred to as a “scene.” Scenes comprise assets (along with any associated and relevant rotatable element metadata) that can be displayed on a given side of a rotatable element. Scenes can include one or any combination of two-dimensional content, three-dimensional content (e.g., content that appears to “hover” off the surface of a rotatable element, as shown in FIG. 2), text content, video content, image content, and so forth. An asset is any piece of data, including but not limited to images, videos, sounds, text, and 3D models, that can be displayed in a scene via a rotatable element. These assets, along with associated rotatable element metadata, form the building blocks for the content that users can interact with and explore by rotating the rotatable element.

Other advantages exist in addition to increasing content density via rotatable element having concealed scenes. As 3D models and 3D photos (for example, photogrammetry) become more accessible, there are not enough practical ways to showcase 3D objects on webpages, especially for non-technical users. Existing carousels that slide images, video players, and scrolling parallax tools, when embedded into a webpage, are primarily designed for 2D content. Consequently, these traditional methods are inadequate for conveying depth of 3D shapes to users. By contrast, rotatable elements offer a unique approach specifically tailored for integrating 3D assets into 2D webpages, enabling a more immersive and engaging experience.

Rotatable elements also address memory footprint issues related to using three-dimensional assets. Generally, three-dimensional assets require more memory than conventional two-dimensional assets. As a result, loading three-dimensional assets can often introduces noticeable latency when those assets are only loaded upon reveal. Embodiments of the inventive subject matter are able to hide any latency associated with loading three-dimensional content by loading three-dimensional content before a scene comprising the three-dimensional content is revealed by a user rotating a rotatable element.

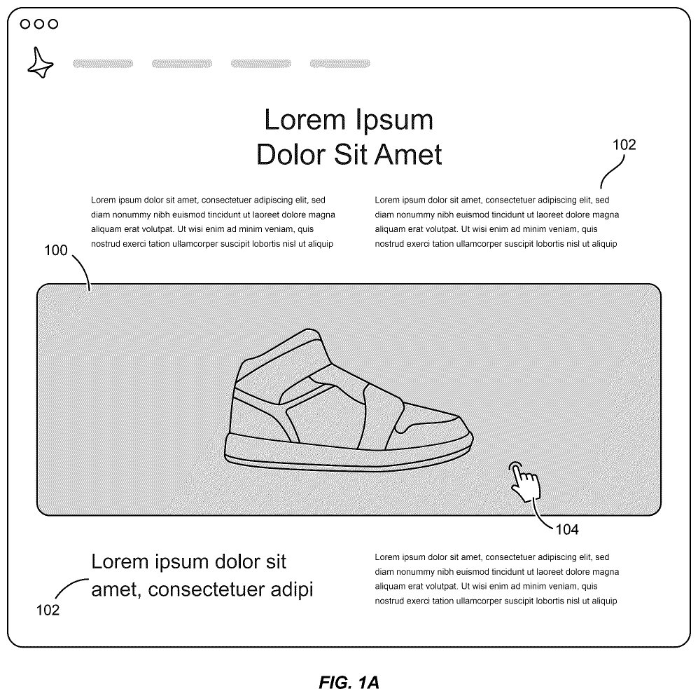

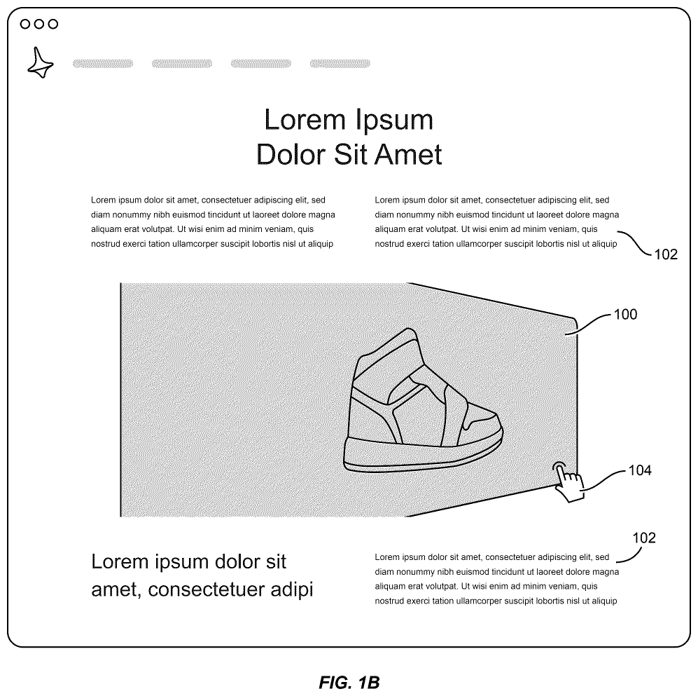

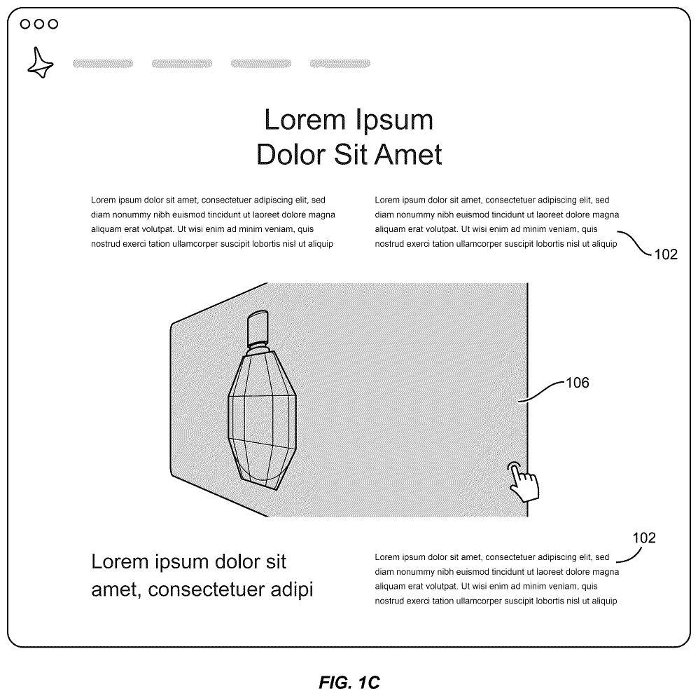

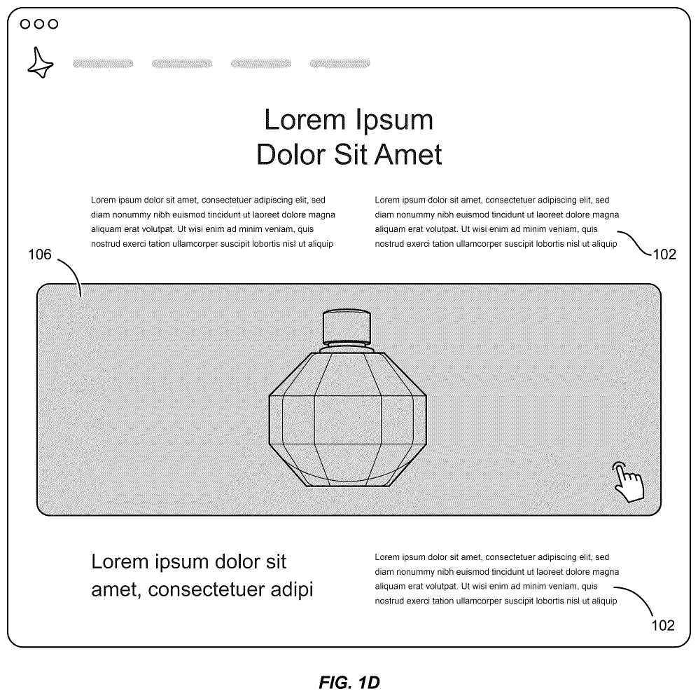

FIG. 1A shows an example of a user interface that features a rotatable element 100. As a user reads through text content 102, the user encounters rotatable element 100. A portion of a user interface that can contain or otherwise house a rotatable element can be visually distinct from other portions of the user interface. For example, in some embodiments, a portion of a user interface having a rotatable element can be identified by a special icon, an animation that previews that the rotatable element can be rotated, a border, text, and so forth.

Text content 102 shown in this and subsequent figures can be, e.g., a portion of a website or some other user interface. While this figure shows (and subsequent figures show) text content, this should not be viewed as restricting, and any other type of content (or absence of content) can exist on any side of a rotatable element of the inventive subject matter. For example, text content, image content, video content, three-dimensional objects, three-dimensional environments, two-dimensional content, and advertising content can all be featured in user interfaces having rotatable elements of the inventive subject matter. In some embodiments, scenes can feature interactive UI elements such as buttons, hyperlinks, games, and so on. For example, a scene can include a play/pause button to control video playback within the scene. In another example, buttons are provided to zoom into images, rotate 3D assets, or reveal additional assets within the scene.

And although the figures in this application show text content above and below rotatable elements of the inventive subject matter, any type of GUI content can be positioned above, below, or on the left or right of a rotatable element. Rotatable elements of the inventive subject matter are also shown as rectangular, but there is no reason they cannot be formed as other shapes, regular or irregular.

Rotatable element 100 is disposed within surrounding text content 102, which begins before rotatable element 100 and continues after rotatable element 100. In some embodiments, rotatable element 100 can be, e.g., an advertisement or image content that is pertinent to text content 102. To access content that is hidden behind rotatable element 100, a user can click on rotatable element 100 and drag their cursor 104. In embodiments adapted for touch screen interfaces (e.g., a capacitive touch screen or the like), users can drag a finger or a stylus along the screen with contact beginning on rotatable element 100. Movement of rotatable element 100 is thus dependent on a user's input movement. Speed of rotation can vary according to the speed that a user drags their cursor or finger.

FIG. 1B shows rotatable element 100 in a state of partial rotation. Cursor 104 represents either an operating system's cursor on a screen or a user's finger (or stylus) contacting a touch screen. By clicking and dragging (or touching and dragging) from left to right, rotatable element 100 begins to rotate out of plane relative the rest of the interface (and relative to text content 102). FIG. 1C shows rotatable element 100 rotated more than 90 degrees about an axis of rotation, thus beginning to reveal content on its back side.

FIG. 1D shows rotatable element fully rotated to reveal new content 106 (e.g., rotated 180° from its initial orientation). New content 106 (which can be referred to as a “concealed scene” or a “supplementary scene”) can be any type of visual content including text, graphics, two-dimensional elements, three-dimensional elements, and so on. In some embodiments, rotatable elements can be configured to snap into one of several configurations. For example, if a rotatable element has been rotated less than 90 degrees, it can snap back to its original orientation (e.g., 0 degrees), while if a rotatable element has been rotated more than 90 degrees, it can snap to a rotated orientation (e.g., 180 degrees from its starting orientation) to reveal content on its back side. In some embodiments, causing a rotatable element to rotate in the same direction after it has already rotated once (i.e., after a rotatable element has rotated 180 degrees, rotating it an additional 180 degrees in the same direction) can reveal even more concealed scenes on subsequently revealed sides of the rotatable element, thus further increasing information and content density of a user interface.

Notably, although this application often refers to things that are “two-dimensional” and “three-dimensional,” it should be understood that three-dimensional objects, environments, etc., can all be two-dimensional representations of three-dimensional content, at least because the content can be viewed on a flat display. In some embodiments, three-dimensional objects can be represented in augmented or virtual reality in which the three-dimensional nature of the objects is visually apparent (e.g., each eye is given a different, offset image to create an illusion of depth), though many embodiments are represented on screens that cannot inherently create depth of field and instead represent three-dimensional objects in two dimensions.

Thus, any kind of digital user interface can incorporate rotatable elements of the inventive subject matter. Rotatable elements feature scenes that can include one or any combination of videos, images, three-dimensional objects, text content, three-dimensional environments, and so on. FIG. 2, for example, shows rotatable element 200 that has been rotated to reveal a scene comprising a three-dimensional object 202 floating over a two-dimensional background. As with FIGS. 1A-1D, rotatable element 200 is shown as sandwiched between written content 204. As the scene comprising three-dimensional object 202 is revealed by reorienting a rotatable element, the three-dimensional object 202 is shown and rendered offset from a surface of the rotatable element. In other words, it appears to hover some distance from a surface of rotatable element 200, despite three-dimensional object 202 being an asset of a scene that is associated with a side of rotatable element 200. In cases where a scene asset (such as a three-dimensional element) offset from a background plane and included in a concealed scene, that asset can be rendered and shown even before a rotatable element of the inventive subject matter has rotated far enough to fully hide an initial scene, such that the relevant asset (or assets) from the concealed scene becomes visible even before the initial scene is even rotated out of view.

Thus at runtime, embodiments are configured to identify rotatable elements and to differentiate user interactions with rotatable elements from user interactions with other portions of a user interface. For example, when a user clicks and drags their mouse (on a computer by clicking and dragging) or drags their finger (on a mobile device by touching and dragging) across a rotatable element, their input is interpreted by the user interface as causing the rotatable element to rotate about an axis of rotation. Rotation speed can be defined as a function of cursor or finger movement speed. For example, speed of rotation (or reorientation) can be proportional to a speed of a movement cursor or finger movement, and the angular value of a rotation can then proportional to the distance of the movement. In some embodiments, flicking or even just tapping or clicking a rotatable element can result in a rotation to display its back side, which would not require any kind of proportional movement.

It should be understood that if, for example, a rotatable element rotates about a y-axis, then movements that comprise vector components in both an x-direction and a y-direction, embodiments can interpret those movements in several different ways. For example, in some embodiments only x-direction movements will be considered in how a rotatable element should rotate, while in some embodiments, some or all of the y-direction movement can be considered in determining how a rotatable element should rotate.

In some embodiments, rotatable elements of the inventive subject matter can rotate as a user scrolls through a user interface. For example, in a web page where text content extends beyond the page's visible area, as a user scrolls to reveal more text content, a rotatable element on the page can rotate as a function of the page scrolling.

In some embodiments, different content can be revealed by a rotatable element depending on the direction that it is rotated. For example, if a rotatable element is rotated clockwise, it can reveal a first concealed scene and if it is rotated counter-clockwise it can reveal a second concealed scene that is different from the first scene.

As discussed throughout this application, scenes of the inventive subject matter can include two-dimensional content, such as pictures or videos. Two-dimensional scene content can be converted into a three-dimensional object (or mapped onto a three-dimensional object), where the three-dimensional object is the rotatable element. This can be done by representing two-dimensional content on a plane that is placed in three-dimensional space such that, in a starting orientation, for example, the plane appears coplanar with other content in a user interface that the rotatable element is embedded into. Next, an axis of rotation or a point about which rotation can occur is defined. In some embodiments, rotatable elements of the inventive subject matter rotate about an axis, while in other embodiments, rotatable elements can rotate about a single point in any direction. In some embodiments, multiple axes of rotation can be defined such that a rotatable element can rotate about, e.g., a vertical axis or a horizontal axis. Different scenes can be revealed depending on which axis a rotatable element is rotated about. Throughout the remainder of this application, an “axis” of rotation may be included in discussion. This term encompasses an axis, a point, multiple axes, multiple points, and so forth.

By defining an axis of rotation, the nature of how a rotatable element can rotate is defined. Defining an axis of rotation for a rotatable element is akin to defining how a virtual camera (e.g., a vantage point of an end user) can rotate around a rotatable element, while holding all other content in a user interface in the user's field of view. Either way, the next step is to define aspects of the three-dimensional scene that can be interacted with by end users. For example, if a three-dimensional scene includes a three-dimensional object hovering over a two-dimensional background, the three-dimensional object can be interacted with by an end user by, e.g., rotating the object in free space, clicking the object (e.g., to trigger an object's animation), moving the object, and so on.

Rotatable elements can be defined such that they can rotate according to a virtual camera that mimics a user's vantage or perspective in viewing a user interface. To do this, a scene that contains visual information is first authored. Authoring scenes can include the following steps. If the scene contains any two-dimensional graphics such as videos or images, the two-dimensional graphics are converted to three-dimensional objects. Because even a scene having only two-dimensional assets needs to be rendered as a rotatable element rotates, scenes can all be converted to three-dimensional objects to facilitate rendering them as a rotatable element changes orientation, which affects how it is shown on a user's screen. This is accomplished by representing a scene as a plane that is textured with the two-dimensional graphics and placed in three-dimensional space such that the plane's normal, and a camera's viewing direction are aligned, pointing in opposite directions (i.e., the camera is facing the plane).

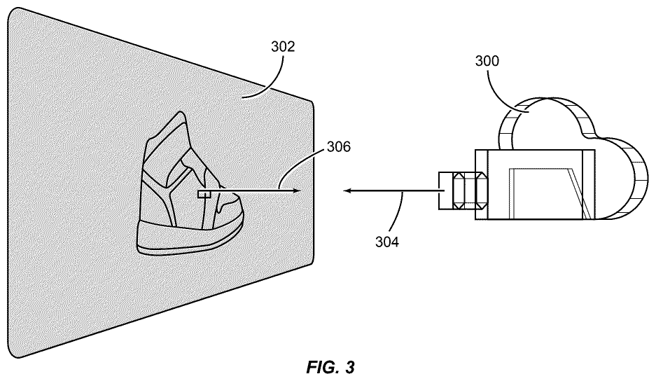

Next, a point or axis in three-dimensional space about which the camera should orbit (or a point or axis about which a rotatable element should rotate) is defined and recorded. The location of this point or axis can be expressed in Cartesian, cylindrical, or spherical coordinates. An example of this setup is shown in FIG. 3, where a camera 300 faces a rotatable element 302, where the camera's normal line 304 is pointing toward the rotatable element's normal line 306. Because rotatable elements of the inventive subject matter comprise a flat surface, a normal line extending therefrom is a line that is orthogonal to the flat surface. Next, assets in the scene that a user can interact with are defined and recorded. Contemplated interactions include rotation, scaling, movement, triggering an asset's animation, and so on. After that, an implied (e.g., virtual) camera's optical settings can be defined and recorded. Optical settings can include zoom settings, depth of field, blurring, and so forth. Finally, the rotatable element's metadata is defined and recorded/stored. Metadata should specify the conditions under which scene enabler should display a scene. Some example conditions can include whether a scene is current, a direction of a user's cursor or finger movement, suggestions from a recommendation engine, and so on.

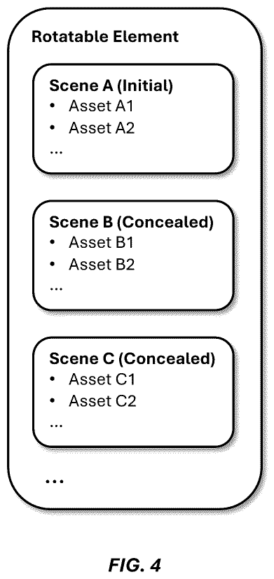

FIG. 4 is a visual representation of a data structure of a rotatable element. It shows a rotatable element comprising scene A, scene B, and scene C, where each scene is rendered on a side of the rotatable element according to how many times it has been rotated. For example, scene A is an initial scene, and so it is rendered before any rotation takes place. Scene B can be revealed after rotating clockwise and scene C can be revealed after rotating clockwise a second time from scene B or after rotating counterclockwise from scene A. Each scene is shown as having several assets, and each set of assets features an ellipsis to indicate there is no true limitation for how many assets a scene can comprise. The same is true for the number of scenes. As discussed in this application, there is no limitation for how many scenes a rotatable element can display other than practical limitations (e.g., user patience for rotating a rotatable element over and over to reveal more scenes).

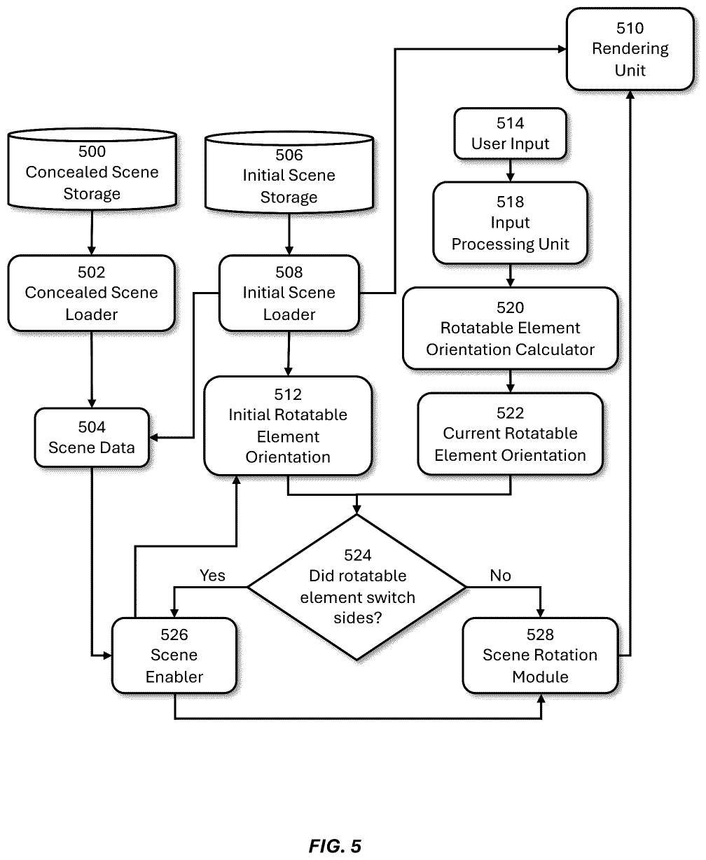

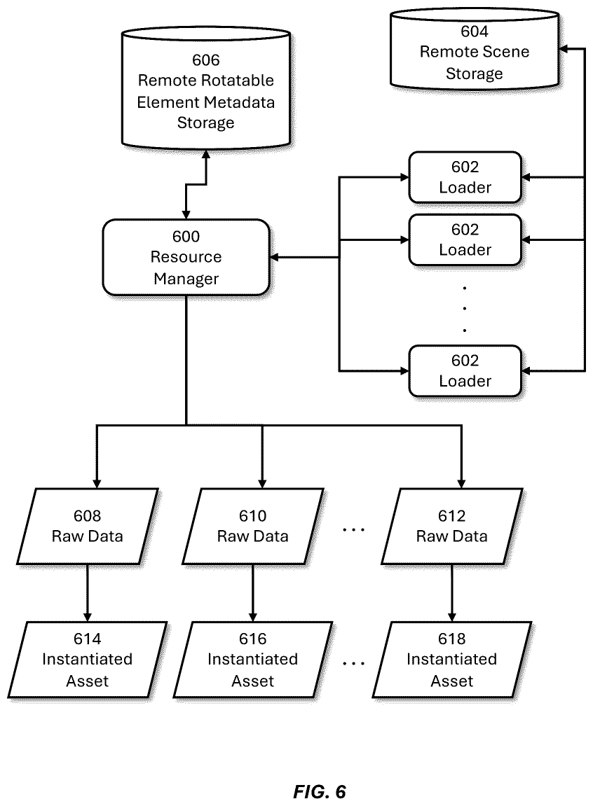

FIG. 5 is a flowchart describing how a system of the inventive subject matter directed to creating and implementing rotatable elements that conceal scenes can work. It should be understood that anything described in FIG. 5 or 6 can be implemented as software executed locally, remotely, or some combination of locally and remotely, even in the absence of explicitly describing how the software is written or where it is executed. A scene can include a three-dimensional element, a two-dimensional element, a video element, an audio element, or any combination thereof. At runtime, concealed scene loader 502 loads concealed scenes from concealed scene storage 500 while the initial scene loader 508 loads an initial scene from initial scene storage 506. In some embodiments, concealed scene loader 502 and initial scene loader 508 can be a single scene loader, which is then spawned to retrieve any scene from any scene storage described in this application. Although scenes are referred to as “initial” and “concealed,” they may also be referred to as “first,” “second,” and so forth without deviating from the inventive subject matter. A concealed scene is one that is not initially visible but that can be revealed by turning a rotatable element, while a scene refers to content that is visible on (or according to an orientation of) a rotatable element of the inventive subject matter.

An initial scene is a scene on a rotatable element that is first shown to a user before a rotatable element is rotated to reveal a concealed scene. When a scene is described as being “on” a rotatable element, this should be understood as also encompassing scenes that comprise three-dimensional content that appears to hover off the surface of a rotatable element on which a scene is rendered. In other words, an initial scene is a visual default for a rotatable element that is part of a GUI or webpage. A concealed scene is a scene that is hidden behind an initial scene and is only visible upon rotating a rotatable element.

Scene data loading can be managed by a resource manager that operates based on rotatable element metadata. Rotatable element metadata can include, e.g.: scene adjacency information, delineating connectivity between scenes; identification of an initial scene (e.g., a unique ID associated with an initial scene); and specification of data requirements for each scene, including, e.g., URLs or other locations of required assets. In some embodiments, rotatable element metadata can also include information defining normal lines for one or more sides of a rotatable element. Scene adjacency information includes information describing what order different scenes can be accessed by rotating a rotatable element of the inventive subject matter.

A resource manager of the inventive subject matter is shown schematically in FIG. 6. A resource manager is module implemented in software and configured to carry out any of the tasks it is described as being responsible for managing in this application. It can be executed or implemented within a web browser, on a platform server, locally, or some combination thereof. All other steps or modules described in either FIG. 5 or 6 should be understood as being software designed to carry out tasks as described in this application. Resource manager 600 is responsible for retrieving scenes and rotatable element metadata such that rotatable elements of the inventive subject matter are able to rotate to reveal new scenes without introducing any perceivable stuttering or loading. Everything discussed in relation to FIG. 6 should be viewed as explanatory of aspects of the content disclosed in relation to FIG. 5. Resource manager 600 spawns loaders 602 to retrieve scene data from remote scene storage 604. Loaders can be configured to retrieve data for entire scenes (e.g., concealed scene loader and initial scene loader in FIG. 5), assets from scenes (e.g., the loaders described in FIG. 6), or any combination thereof. Three loaders 602 are shown with an ellipsis separating the second and the third, indicating that there is no set number of loaders that can be loaded. In some embodiments, only one loader is needed, while in some embodiments two or more can be needed.

Remote scene storage 604 is used to store scene assets (and it is modeled as two separate components in FIG. 5 as initial scene storage 506 and concealed scene storage 500). A single rotatable element can feature multiple scenes, but only one scene can be viewed at a time. Thus, a loader may not need to pull all scene assets from remote scene storage 604 at once and can instead strategically load assets in anticipation of a need for those assets. For example, when a scene is visible on a rotatable element, only those scenes one rotation to the left and right (or up and down, or in any other direction of rotation about which a new scene can be revealed) of that scene may need to be loaded, but a scene that is two rotations away from a current scene would not need to be loaded yet and would thus be assigned lower loading priority than, e.g., a concealed scene that will be revealed after a single rotation (e.g., a single 180-degree rotation of a rotatable element).

Remote rotatable element metadata storage 606 is used to store metadata associated with a specific rotatable element. In other words, rotatable elements comprise multiple scenes that each have scene assets, while metadata relates to the rotatable element in its entirety, not to each specific scene. Rotatable element metadata can be retrieved by resource manager 600 prior before spawning loaders and can be used by resource manager 600 to determine how many and what type of loaders to spawn. Rotatable element metadata can indicate, e.g., conditions under which rotatable elements can be interacted with and can include parameters relating to how rotation can occur. For example, each rotatable element can include metadata indicating an orientation about which a rotatable element can rotate, a three-dimensional object offset distance, etc.

Metadata relating to rotatable elements of the inventive subject matter is thus accessible to resource manager 600. Rotatable element metadata can be subdivided per scene (or scene asset). Subdivided metadata for each scene includes information such as: a URL of each asset in the scene; placement of each asset in a given scene including translation, rotation, and scale information; an indication whether an asset is animatable, and if it is, the metadata will also include information needed to run the animation; rendering information (e.g., information about colors that needed to apply to an asset, its transparency information/alpha channel, and for 3D assets, a light source location); a relation between assets in a scene (e.g., by clicking or tapping on an asset, another asset might be hidden or displayed-this can be considered UI or UX information); information on how a user can interact with an asset in a scene (e.g., in case of video whether it needs a play button to play or it starts playing automatically as soon as the given space is reached); and in scenes with three-dimensional objects, information indicating whether the three-dimensional object can be rotated independently from the rotatable element (e.g., if a scene features a three-dimensional representation of a purse, once the rotatable element has been turned enough to make the purse visible, a user could then rotate the purse to see all its sides). Rotatable element metadata can also include a camera's optical settings associated with a given scene. In some embodiments, metadata can also indicate how to modify a downloaded asset and how to create an asset. For example, metadata can indicate that one or more assets should be generated on demand using one or more AI models to create any type of asset described in this application using generative AI techniques.

Data retrieved by loaders 602 can then be written to local RAM. A “loader” is a piece of software responsible for loading data (e.g., programs, libraries, images, videos, and other assets) into memory, preparing them for use. This process can involve either memory-mapping or copying data (e.g., a file, a program executable, etc.) into memory. Once loading is complete, a computer system is able to quickly access any data loaded into memory.

In the context of loading a program into memory, for example, loaders perform several tasks, including allocating memory space, relocating data to appropriate memory addresses, and resolving external references between different parts of the program. The same is largely true for any other type of data that is loaded into memory.

In Unix systems, for example, a loader can handle the system call execve( ) which includes tasks such as validating permissions and memory requirements, memory-mapping the executable object from the disk into main memory, copying command-line arguments into virtual memory, initializing registers, and jumping to the program entry point.

In Microsoft Windows, for example, an example of a loader is the LdrInitializeThunk function contained in ntdll.dll, which performs tasks such as initializing structures in the DLL, validating the executable to load, creating a heap, allocating environment variable blocks, loading the executable's imports, and more.

In embodiments described in this application, resource manager 600 dispatches loaders 602 within a browser to eliminate latency in communications between a front end and a back end that can result from a user's input (e.g., mouse movement/finger drag). Loaders of the inventive subject matter are thus OS agnostic and are preferably implemented as web workers (e.g., as JavaScript scripts that run in the background, independently of the main thread, where resource manager 600 runs). This configuration allows for offloading heavy loading tasks without interfering with a user interface.

Remote storage locations that loaders 602 of the inventive subject matter can pull data from include file servers, cloud storage services, and other types of networked storage systems. In some embodiments, local storage systems can also store scene content and rotatable element metadata. Once scene metadata is retrieved from remote rotatable element metadata storage 606 and scene assets are retrieved from remote scene storage 604 by loaders 602, loaders 602 write scene assets to local RAM that resource manager 600 can access. Because some scenes associated with a given rotatable element can use repeated assets, resource manager 600 is responsible for detecting when an asset is repeated and not loading that asset multiple times.

Remote storage locations of the inventive subject matter can be accessed over different types of networks, such as the Internet, LAN, WAN, or VPN. Resource manager 600 can thus spawn loaders 602 to retrieve scene data from these remote storage locations using specified URLs and subsequently load this data into local RAM. URLs indicating locations for assets can be stored in rotatable element metadata. Loaders 602 spawned by a resource manager of the inventive subject matter can also pull content from Network Attached Storage (NAS) systems, which are designed for easy and convenient administration of data archive processes from anywhere in the world.

In some embodiments, resource manager 600 can operate on a main thread while spawning loaders 602 in the form of web workers. Web workers can be, e.g., JavaScript scripts that run in the background, independently of other scripts, without affecting the performance of a webpage. Web workers can perform tasks such as network requests using the fetch( ) or XMLHttpRequest APIs, and they can communicate with the main thread by posting messages to an event handler specified by the main thread. Web workers can be created using a constructor (e.g., Worker( ) that runs a named JavaScript file containing the code that will execute in the worker thread. There are two types of web workers: dedicated workers, which are accessible only by the script that created them, and shared workers, which can be accessed by multiple scripts

Web workers of the inventive subject matter thus function in separate threads and do not possess direct access to the memory of the main thread (including RAM). Communication with resource manager 600 is achieved through message passing, whereby notifications such as task completions or error states are transmitted. Web workers improve performance of systems of the inventive subject matter at least by allowing JavaScript to run in the background, freeing up the main thread for other tasks, resulting in a more responsive user interface and smoother performance. They can perform tasks such as network requests using the fetch( ) or XMLHttpRequest APIs, and they can communicate with the main thread by posting messages to an event handler specified by the main thread. By implementing web workers, web application performance and user experience is improved.

In view of limited system resources, resource manager 600 can regulate the number of active loaders 602 at any given time. Resource manager 600 schedules loaders 602 with consideration to data priority, determined by factors such as memory availability and proximity between a currently visible scene and a scene being loaded (with proximity measured by the number of intervening scenes a user must traverse before interacting with the scene being loaded).

Some scene data can be considered optional and can then be required only if a user engages in specific actions. For example, some scene data can be considered optional because it will not be immediately visible to a web page visitor, but, when that web page visitor interacts with a rotatable element of the inventive subject matter, the optional scene data can become required because it will need to be displayed. This optional scene data is assigned a lower priority, and thus resource manager 600 could schedule a loader 602 accordingly.

Resource managers of the inventive subject matter administer memory management in RAM, which can include tasks like deallocating memory for scenes that have been visited but are now distant from a current scene (meaning a user has rotated a rotatable element a number of times away from a visited scene) and instantiating objects from raw scene data. Initially, all scene data is loaded into RAM via loaders in a compact raw format. Assets for an initial scene are then instantiated from this raw data. Thus, a resource manager of the inventive subject matter can cause a loader to retrieve raw data relating to a given asset and make that raw data accessible to the resource manager that then instantiates the asset from that raw data. For example, embodiments of the inventive subject matter use a high efficiency file format for three-dimensional Gaussian splattings (i.e., a type of three-dimensional photo). Raw data relating to a Gaussian splatting can be loaded into RAM and then when enough resources are available, the resource manager can instantiate the Gaussian splatting asset from the raw data and then delete the raw data.

As additional memory becomes available, resource manager 600 progressively instantiates objects for other scenes. Thus, FIG. 6 shows raw data 608 being used to create an instantiated asset 614. The same is true for raw data 610 and raw data 612, which give rise to instantiated asset 616 and instantiated asset 618, respectively. Ellipses are included to demonstrate that more than three instantiated objects and more than three portions of the raw data can be implemented. It should also be understood that although three of each are shown, this should not be seen is requiring three raw data portions or instantiated objects. In the field of computer software, instantiating something from raw data involves transforming unprocessed information into a structured format that can be used for another purpose. In this case, raw data is used to instantiate objects that comprise scene data (e.g., scene assets), and that scene data can thus be used in embodiments of the inventive subject matter. Raw data is loaded into RAM (instead of instantiated assets) because raw data takes less RAM. Raw data in this context comprises assets that are compressed and otherwise inaccessible or unusable to an end user. Thus, objects instantiated from raw data can include scene assets, and scene assets can feature any files (e.g., images, videos, 3D objects, or the like) that are necessary to display a scene on or in relation to a rotatable object.

Moving back to FIG. 5, in some embodiments, concealed scene loader 502 and initial scene loader 508 can be handled by a single loader and both concealed scene storage 500 and initial scene storage 506 can also be handled by a single storage solution. These different modules are shown and described as separate modules only for explanatory purposes, though it can be advantageous to keep each of these subsystems separate. By keeping concealed scene loader 502 and initial scene loader 508, as well as initial scene storage 506 and concealed scene storage 500, separate, embodiments can, e.g., load an initial scene first (or at least assign it a higher loading sequence priority) and load concealed scenes as background processes (or assigning concealed scenes lower priority for loading). To load a scene generally involves a resource manager spawning one or more loaders that are capable of, either alone or together, loading all assets of a particular scene.

This is advantageous because the initial scene is what a user sees first, which has the effect of hiding latency. Concealed scene loader 502 and initial scene loader 508 are configured to retrieve concealed scene data and initial scene data, respectively, and to store any retrieved scene data 504 to scene data memory. Initial scene loader 508 also sends initial scene data to rendering unit 510 and stores initial rotatable element orientation 512 to memory (e.g., to RAM or other memory that can function similarly). An initial orientation of a rotatable element can be assigned.

A rotatable element's initial orientation can be assigned or otherwise defined in rotatable element metadata associated with a particular rotatable element. In some embodiments, having a given rotatable element appear coplanar with other user interface elements surrounding it can be a default setting. In such an orientation, the rotatable element can be considered as having a 0° angular orientation, where an N×180° (where N is an integer number of rotations) angular orientation would be a full rotation to reveal a concealed side of the rotatable element. Rotatable elements of the inventive subject matter can be initially oriented at any angular orientation.

In addition to modeling embodiments according to an orbiting virtual camera, some embodiments can be described as user interface that features a static virtual camera (e.g., a perspective that describes how a user would view a user interface) that faces a rotatable element that rotates according to an axis of rotation that is defined in relation to the user interface that the rotatable element is incorporated into. In any event, the concept of a “virtual camera” is a stand in for an end user's perspective when viewing a user interface having a rotatable element of the inventive subject matter, regardless of how movement of the rotatable element is then described (e.g., by describing a camera movement or by describing movement of the rotatable element itself).

Concealed scene storage 500 and initial scene storage 506 can be implemented on one or more file servers. A file server is a computer attached to a network that provides a location for shared disk access, allowing storage of computer files such as text, image, sound, three-dimensional data, and video. File servers can be dedicated or non-dedicated, with dedicated servers designed specifically for file storage and non-dedicated servers performing other tasks as well. They can be accessed using various protocols such as SMB/CIFS for Windows and Unix-like systems, NFS for Unix-like systems, and FTP or HTTP for Internet file servers.

While a file server can be implemented for scene storage, a computer system is needed to, e.g., receive and interpret user input 514. Computer systems of the inventive subject matter can be any type of computing device capable of rendering a graphical user interface of the inventive subject matter, either as a standalone app or as a web page, while also receiving user input. User input to a computer can be provided through various input devices, each serving different purposes. A keyboard allows users to input data by typing letters, numbers, and functions. A mouse controls the movement of the cursor on a display screen. A joystick can provide two-dimensional or three-dimensional input. A touchscreen can allow users to interact with a computer by touching the screen. A microphone converts sound waves into electrical signals for audio input. Systems of the inventive subject matter can receive input by any of these means.

When user input 514 is received, it is interpreted by an input processing unit 518. Input processing unit 518 determines whether a rotatable element has been interacted with by a user input. Users can interact with rotatable elements by, e.g. clicking and dragging, pressing a key, or using a finger (on a touch interface) to rotate the element to reveal a concealed scene on a concealed side of the rotatable element by turning the rotatable element until the concealed side visible. Input processing unit 518 interprets these inputs.

A computer mouse works by translating movements of a mouse into signals that the computer can use. In an optical mouse, a laser reflects off a surface (e.g., a desk or mousepad) and changes in angles of reflection as the optical mouse moves are recorded, which the mouse interprets as movement. Signals corresponding to mouse movements are then transmitted from the mouse to the computer, and the computer can then interpret those signals to cause a cursor to move on a display screen. These same mouse movement signals can be used by embodiments of the inventive subject matter to determine how a rotatable element should move. In some instances, moving a cursor over a portion of a user interface comprising a rotatable element can cause the rotatable element to move (i.e., without clicking, in cases of a computer mouse), while in other embodiments, a user must click and then drag their cursor to cause a rotatable element to move. Digital signals comprising mouse movement information are considered user inputs of the inventive subject matter.

Touchscreens work by sensing the position of a user's finger or stylus on a screen and translating that into digital signals. There are several types of touchscreens, including resistive, capacitive, infrared, and surface acoustic wave (SAW). Resistive touch screens feature two layers separated by a thin gap. When a user presses the screen, the layers touch, creating an electrical connection that the touchscreen detects. Capacitive Touchscreens use a layer that stores an electrical charge. When a user touches the screen, it disrupts the charge, and the touchscreen measures this change to determine the touch location. Infrared touchscreens use a grid of infrared beams. When a user touches the screen, they interrupt these beams, and the touchscreen detects the touch location based on the pattern of interruptions. And finally, surface acoustic wave (SAW) touchscreens detect touch by measuring vibrations caused by a user's touch.

Once the touchscreen detects a user's touch, it sends digital signals corresponding to the user's touch to a computer's processor, which interprets the digital signals corresponding to the user's touch and translates it into specific actions like opening an app, typing a letter, dragging a finger across a screen and so on. Digital signals corresponding to a user's touch can be transmitted with time information or in real-time such that a user's actions are interpreted as they occur. Touch actions and movements are considered user inputs in embodiments of the inventive subject matter.

In instances where a user input has interacted with a rotatable element, a rotatable element orientation calculator 520 determines a current orientation of the rotatable element, accounting for how the user input may have impacted rotatable element orientation. In some embodiments, user inputs such as mouse or touch actions can be translated by input processing unit 518 into screen pixel coordinates and/or active canvas coordinates. Input processing unit 518 carries out translations of movement information to coordinate information that can then be used by rotatable element orientation calculator 520. A current rotatable element orientation 522 is known after performing this calculation. Current rotatable element orientation 522 can be defined according to any defined coordinate system.

A computer system of the inventive subject matter has RAM to store, e.g., scene data 504, initial rotatable element orientation 512, and a current rotatable element orientation 522. Once a current rotatable element orientation 522 and an initial rotatable element orientation 512 are known, the system can determine whether the rotatable element has rotated enough to reveal a side of the rotatable element that is not visible according to its initial orientation (as defined by initial rotatable element orientation 512). To determine whether a rotatable element has switched sides (e.g., rotated enough so that a first side is no longer visible and a second side is visible), a decision unit 524 compares the initial rotatable element orientation 512 to the current rotatable element orientation 522. If the rotatable element has rotated enough that a new side of the rotatable element becomes visible, then scene enabler 526 passes scene data 504 retrieved by concealed scene loader 502 to scene rotation module 528, which determines how a scene content should be rendered according to a rotatable element's current angular orientation. Scene enabler 526 is also responsible for updating the definition for an initial orientation. In other words, once a rotatable element has rotated enough to reveal a concealed side, the initial orientation should be updated so that the once-concealed-but-now-currently visible side of the rotatable element becomes the new initial orientation. Thus, if the rotatable element again rotates such that the currently visible side becomes concealed, decision unit 524 would yield a “yes.”

Whether a new side of a rotatable element becomes visible can be determined by, for example, comparing an angle of a normal line extending from a visible side of a rotatable element to a camera (e.g., the user's vantage) normal line. Once that angle goes beyond 90 degrees, the rotatable element's orientation will have changed sufficiently that a concealed side will begin to become visible.

Next, rendering unit 510 causes a graphical representation of the rotatable element showing the concealed scene (which is no longer concealed) to be displayed within a GUI on a user's device, showing the rotatable element in an angular orientation that is determined according to a user's input. And if the rotatable element has not switched sides, then scene rotation module 528 determines how the currently displayed scene (e.g., the initial scene) should be shown and the scene rendering unit 510 can then cause the rotatable element to be shown with that scene at a specific angular orientation within a GUI.

Rendering unit 510 is responsible for causing scenes to be rendered. In some embodiments, each scene that is rendered forms a side of a rotatable element of the inventive subject matter. In other words, the rotatable element itself is emergent in rendering an initial scene with one or more concealed scenes that can be revealed by rotating the initial scene, thus forming a rotatable element. For convenience of conceptualization, rotatable elements can be thought of as having “sides” with scenes rendered thereupon, even if a side only exists because a scene has been rendered to form that side (and nothing is rendered “on” a side of a rotatable element at all). By relying on this conceptualization, rotatable units of the inventive subject matter can be more easily described as distinct virtual structures, even if their structure is actually emergent from the rendering of two or more scenes. Any time a scene is described as being rendered “on” a side of a rotatable element, it should be understood that the scene itself indeed makes up that side of the rotatable element.

The work of rendering unit 510 can thus be thought of more generally as rendering a rotatable element by way of rendering scenes that make up the rotatable element. Rendering a rotatable element therefore implies rendering everything associated with the rotatable element including any scenes and all associated scene assets. For example, an initial scene can be displayed after an initial scene is loaded by initial scene loader 508. Rendering units of the inventive subject matter cause a user's computer to display (e.g., on the computers display screen) a user interface having a rotatable element of the inventive subject matter. In some embodiments, rendering units are more narrowly targeted to causing just the rotatable elements to be displayed, while in others the rendering units cause entire user interfaces to be displayed. Rendering unit 510 can also display a rotatable element rotating from an initial orientation to a current orientation by receiving instructions from scene rotation module 528. Scene rotation module 528 develops orientation information that allow rendering unit 510 to display a rotatable element in a correct angular orientation according to a user input. Orientation information describes how a rotatable element is oriented relative to a user interface that it is embedded within. In other words, orientation information defines how a rotatable element is oriented according to a viewer's perspective of a user interface. Orientation information can include current orientation as well as orientations of the rotatable element as a function of time sufficient to describe how a rotatable element has moved according to a user's input. Orientation information for a given rotatable element can be described in a variety of different ways, including in different coordinate systems (e.g., cartesian, cylindrical, spherical).

As discussed above, in instances where decision unit 524 determines that a rotatable element has rotated enough to show a concealed scene, scene enabler 526 retrieves a concealed scene from scene data 504 and thus enables that scene to be displayed. The scene rotation module 528 then creates rotation parameters that it passes on to rendering unit 510, such that rendering unit 510 causes the concealed scene to be revealed upon rendering the rotatable element rotating enough to show a concealed side.

But if a rotatable element has not rotated enough to cause a concealed scene to be revealed, then scene enabler 526 is not required, and instead scene rotation module 528 develops rotation parameters that fall short of giving rise to a rotation that would reveal a concealed side of a rotatable element. Thus rendering unit 510 would not need to show a new scene and instead just needs to render the rotatable element rotating according to a user input (if any).

Embodiments of the inventive subject matter can be implemented in a variety of different contexts. For example, a rotatable element can an image of a product such that rotating it clockwise provides additional product images and videos with each subsequent rotation. Users can retrace their steps by spinning the rotatable element counterclockwise (i.e., undoing the rotations). Depending on where the user clicks on the rotatable element, the user's input (i.e., the input that results in rotating the rotatable element) can have a different result. For example, if a rotatable element is a fashion photo of a model in jeans and shoes and the user clicks and drags starting on the jeans, the user is presented with additional images and videos of the jeans. Likewise, if the user clicks and drags on the shoes, the user is presented with additional images and videos of the shoes. This effect is available in videos as well, based on, e.g., a timestamp and screen location of a user's input action on a video.

In some embodiments, rotating a rotatable element one direction from its original orientation can have a different action from rotating it in the other direction. For example, rotating a rotatable element counterclockwise can reveal a virtual three-dimensional store experience with multiple products, while rotating it clockwise can reveal text information about a product or set of products. In the same way, different actions can occur when a user rotates from top to bottom or the reverse. Direction of rotation can be determined according to user input (e.g., did they drag left or right up or down), which can result in a measurable difference between a current rotatable element orientation and an initial rotatable element orientation. Direction of orientation change correlates to direction of rotation. Rotations are not limited to left and right (clockwise and counterclockwise), and any direction of rotation can be used to reveal concealed scenes. In effect, rotations are only limited by practical limitations that arise from receiving inputs corresponding to rotating actions, as any rotation or any number of rotations in a particular direction can result in a different (unique) scene being displayed. If too many rotation directions are defined, it may become impractical or difficult to access certain content.

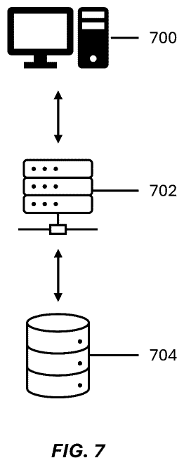

FIG. 7 shows an example of how embodiments of the inventive subject matter can be brought to life in an example hardware environment. It shows a computer 700, a remote server 702, and remote storage 704. Computer 700 can be, e.g., a user's computer running executable software or a web browser, and computer 700 comprises one or more processor, storage, and memory that are all configured to execute software. Thus using software or a web browser, computer 700 thus runs the resource manager as described in FIG. 6, and the resource manager is configured to carry out the steps described in FIG. 5 that can be executed locally on computer 700. For example, computer 700 can receive user input, it can process user input, it can carry out rotatable element orientation calculations, and it can determine a current rotatable element orientation. In some embodiments, carrying out rotatable element orientation calculations and determining current rotatable element orientations can be conducted by remote server 702. Computer 700, via the resource manager, can spawn loaders and run those loaders to retrieve raw data. Computer 700 can instantiate assets from retrieved raw data, as well.

Remote server 702 is coupled (e.g., via network or hardware connection) to remote storage 704. In other words, remote server 702 comprises one or more processors, storage, and memory all of which are able to interact with remote storage 704 via either network connection or via local connection (e.g., remote storage 704 can be remote to computer 700 but local to remote server 702). Remote storage 704 can comprise remote scene storage and remote rotatable element metadata storage. Although remote storage 704 is modeled in FIG. 7 as a single database, it should be understood that remote storage 704 can be made up of one or more different databases that exist across different hardware components (e.g., some local to remote server 702 some accessible via network connection).

Thus, specific systems and methods directed to user interfaces having rotatable elements have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of loading and displaying a rotatable element in a user interface, the method comprising the steps of:
running, on a computing device, a resource manager;
spawning a concealed scene loader using the resource manager;
spawning an initial scene loader using the resource manager;
retrieving a concealed scene from concealed scene storage using the concealed scene loader;
retrieving an initial scene from initial scene storage using the initial scene loader;
retrieving rotatable element metadata using the resource manager;
rendering the initial scene to form a first side of the rotatable element while the rotatable element is in an initial angular orientation;
receiving, by the computing device, a user input comprising a mouse movement or a touch movement;
determining a new angular orientation of the rotatable element according to the user input;
comparing the new angular orientation to the initial angular orientation to determine whether to render the concealed scene; and
rendering the concealed scene to form a second side of the rotatable element opposite the first side.

2. The method of claim 1, wherein the concealed scene storage comprises a file server.

3. The method of claim 1, wherein the initial scene storage comprises a file server.

4. The method of claim 1, wherein the rotatable element metadata comprises at least one of:
scene adjacency information;
information delineating connectivity between scenes;
an identification of the initial scene; and
at least one URL corresponding to an asset from the initial scene.

5. The method of claim 1, wherein the user input comprises a click and drag originating on a graphical representation of the rotatable element.

6. A method of loading and displaying a rotatable element in a user interface, the method comprising the steps of:
running, on a computing device, a resource manager;
retrieving a first scene from initial scene storage using the resource manager;
retrieving a second scene from concealed scene storage using the resource manager;
retrieving rotatable element metadata using the resource manager;
rendering the first scene to form a first side of the rotatable element;
receiving, by the computing device, a user input comprising a mouse movement or a touch movement;
determining a movement of the rotatable element according to the user input;
comparing a new angular orientation to an initial angular orientation of the rotatable element to determine whether to render the second scene, wherein the new angular orientation is determined based on the movement;
wherein the new angular orientation causes a second side of the rotatable element to be visible; and
rendering the second scene to form a second side of the rotatable element.

7. The method of claim 6, wherein the concealed scene storage comprises a file server.

8. The method of claim 6, wherein the initial scene storage comprises a file server.

9. The method of claim 6, wherein the rotatable element metadata comprises at least one of:
scene adjacency information;
information delineating connectivity between scenes;
an identification of the first scene; and
at least one URL corresponding to an asset from the first scene.

10. The method of claim 6, wherein the user input comprises a click and drag originating on a graphical representation of the rotatable element.

11. A method of loading and displaying a rotatable element in a user interface, the method comprising the steps of:
running, on a computing device, a resource manager;
spawning a scene loader using the resource manager;
retrieving, using the scene loader, a concealed scene from scene storage;
retrieving, using the scene loader, an initial scene from the scene storage;
retrieving rotatable element metadata using the resource manager;
rendering the initial scene to form a first side of the rotatable element while the rotatable element is in an initial angular orientation;
receiving, by the computing device, a user input comprising a mouse movement or a touch movement;
determining a new angular orientation of the rotatable element according to the user input;
comparing the new angular orientation to the initial angular orientation to determine whether to render the concealed scene; and
rendering the concealed scene to form a second side of the rotatable element opposite the first side.

12. The method of claim 11, wherein the scene storage comprises a file server.

13. The method of claim 11, wherein the rotatable element metadata comprises at least one of:
scene adjacency information;
information delineating connectivity between scenes;
an identification of the initial scene; and
at least one URL corresponding to an asset from the initial scene.

14. The method of claim 11, wherein the user input comprises a click and drag originating on a graphical representation of the rotatable element.
